(19) United States
(12) Patent Application Publication
(10) Pub. No.: US 2009/0013705 A1
(43) Pub. Date: Jan. 15, 2009

(54) Refrigeration apparatus with exhaust heat recovery device

(75) Inventors: Michio Nishikawa, Obu-city (JP); Hironori Asa, Okazaki-city (JP); Keiichi Uno, Kariya-city (JP); Hiroshi Kishita, Anjo-city (JP)

Correspondence Address: HARNESS, DICKEY & PIERCE, P.L.C., P.O. BOX 828, BLOOMFIELD HILLS, MI, 48303, US

(73) Assignees: DENSO CORPORATION, Kariya-city (JP); Nippon Soken, Inc., Nishio-city (JP)

(21) Appl. No.: 12/156,117

(22) Filed: May 28, 2008

(30) Foreign Application Priority Data
May 30, 2007 (JP) 2007-144158

(51) Int. Cl. B60H 1/32; F25B 1/00; G05B 15/00

(52) U.S. Cl. 62/239; 62/498; 700/275

(57) ABSTRACT

A refrigeration apparatus with an exhaust heat recovery device mounted on a vehicle includes a refrigeration cycle for allowing a refrigerant for refrigeration to circulate therethrough, and a Rankine cycle for allowing a refrigerant for the Rankine cycle to circulate therethrough. The Rankine-cycle condenser and the refrigeration-cycle condenser are disposed in predetermined positions of the vehicle in series with respect to a flow direction of external air for cooling, and the Rankine-cycle condenser is disposed on an upstream side of the external air with respect to the refrigeration-cycle condenser.

### CROSS REFERENCE TO RELATED APPLICATION

This application is based on Japanese Patent Application No. 2007-144158 filed on May 30, 2007, the contents of which are incorporated herein by reference in its entirety.

### FIELD OF THE INVENTION

The present invention relates to a refrigeration apparatus with an exhaust heat recovery device for operating an expansion unit using exhaust heat from a vehicle, for example, an internal combustion engine, as a heating source.

### BACKGROUND OF THE INVENTION

A conventional refrigeration apparatus with an exhaust heat recovery device is known in, for example, JP-A-2006-46763. The refrigeration apparatus includes a refrigeration cycle and a Rankine cycle using exhaust heat in cooling of an internal combustion engine serving as a heat generator. A compressor for compressing and discharging refrigerant in the refrigeration cycle and an expansion unit adapted to be operated in the Rankine cycle by expansion of refrigerant heated by the exhaust heat in cooling of the internal combustion engine are respectively independently located. A condenser (radiator) in the Rankine cycle is also used and configured as a condenser for the refrigeration cycle.

Such a refrigeration apparatus permits independent operation of the refrigeration cycle or the Rankine cycle, or the simultaneous operation of both the refrigeration cycle and the Rankine cycle according to the necessity of cooling operation for a vehicle compartment and the possibility of recovery of the exhaust heat in cooling.

In the above-described refrigeration apparatus, however, when the refrigeration cycle and the Rankine cycle are simultaneously driven, the condenser condenses the refrigerant in both the cycles (i.e., radiates heat from both the cycles) at the same time, resulting in an increase in pressure of the refrigerant at the condenser. Thus, a pressure difference between inlet and outlet of an expansion unit of the Rankine cycle becomes smaller, thereby reducing a regenerative power obtained by the expansion unit.

Further, the single operation of only the Rankine cycle may cause a difference in pressure between the condenser and the evaporator in accordance with an increase in pressure of the refrigerant at the condenser even though the refrigeration cycle is stopped, thereby allowing the refrigerant to be collected in the refrigeration cycle side (evaporator side). It may result in a decrease in amount of the refrigerant on the Rankine cycle side, so that an inherent capability of the Rankine cycle cannot be sufficiently exhibited. Moreover, because lubricating oil contained in the refrigerant may also be collected in the refrigeration cycle, shortage of lubrication of the expansion unit or a refrigerant pump may be caused, thus resulting in reduction of reliability on the expansion unit and refrigerant pump.

### SUMMARY OF THE INVENTION

The invention has been made in view of the foregoing problems, and it is an object of the invention to provide a refrigeration apparatus with an exhaust heat recovery device, which includes a refrigeration cycle and a Rankine cycle and which can exhibit sufficient performance to the Rankine cycle while ensuring reliability thereon.

According to an aspect of the present invention, a refrigeration apparatus with an exhaust heat recovery device mounted on a vehicle includes: a refrigeration cycle for allowing a refrigerant for refrigeration to circulate therethrough; and a Rankine cycle for allowing a refrigerant for the Rankine cycle to circulate therethrough. The refrigeration cycle includes a compressor, a refrigeration-cycle condenser, an expansion valve, and an evaporator which are connected in a circular shape. The Rankine cycle includes a pump, a heater using exhaust heat from a heat engine of the vehicle as a heating source, an expansion unit, and a Rankine-cycle condenser which are connected in a circular shape. In the refrigeration apparatus, the refrigeration-cycle condenser and the Rankine-cycle condenser are disposed in predetermined positions of the vehicle in series with respect to a flow direction of external air for cooling, and the Rankine-cycle condenser is disposed on an upstream side of the external air with respect to the refrigeration-cycle condenser.

Accordingly, regardless of the presence or absence of the operation of the refrigeration cycle, the Rankine-cycle condenser constantly allows an external fluid whose temperature is equal to the temperature of outside air to flow thereinto. Thus, it does not lead to a reduce in a pressure difference between the refrigerant inlet and outlet of the expansion unit and a reduce in a regenerative power, without increasing the refrigerant pressure in the Rankine cycle.

Further, in single operation of the Rankine cycle, each cycle constructs a corresponding independent refrigerant circuit, and thus the refrigerant and lubricating oil are not collected from the Rankine cycle into the refrigeration cycle. Accordingly, it can sufficiently exhibit the inherent capacity of the Rankine cycle, and ensure the reliability on the expansion unit and the pump.

Thus, the refrigeration apparatus with the exhaust heat recovery device can exhibit sufficient performance to the Rankine cycle, while ensuring the reliability thereon.

For example, the refrigeration apparatus with an exhaust heat recovery device further includes control means for controlling operations of the refrigeration cycle and the Rankine cycle. Furthermore, the control means may stop the operation of the Rankine cycle under a condition where a power increase amount due to the operation of the Rankine cycle, for operating the refrigeration cycle, is larger than a regenerative power in the Rankine cycle, when both of the refrigeration cycle and the Rankine cycle are simultaneously operated.

Thus, it can prevent the power regenerative amount from being lowered than the power increase amount, thereby preventing an unnecessary operation of the Rankine cycle. Furthermore, because the exterior fluid whose temperature is equal to the temperature of outside air flows into the refrigeration-cycle condenser, it can prevent an increase of the refrigerant pressure in the refrigeration condenser, a power increase consumed in the compressor, reduction in the reliability thereon, and/or a reduce in coefficient of performance of the refrigeration cycle.

Alternatively, the control means may control the number of revolutions of the expansion unit such that a regenerative power of the Rankine cycle has an optimal value under a condition where a power increase amount due to the operation of the Rankine cycle, for operating the refrigeration cycle, is smaller than the regenerative power of the Rankine cycle, when both of the refrigeration cycle and the Rankine cycle are simultaneously operated.

The control means may calculate the power increase amount and the optimal value based on a map previously defined. Thus, the pressure increase amount of the refrigeration cycle and the optimal value of the regenerative power of the Rankine cycle can be easily calculated.

Alternatively, the control means may calculate the power increase amount and the optimal value based on a thermal equilibrium formula of a high-pressure side and a low-pressure side in each of the refrigeration cycle and the Rankine cycle. Thus, the pressure increase amount of the refrigeration cycle and the optimal value of the regenerative power of the Rankine cycle can be accurately calculated.

Positions of an inlet and an outlet of the refrigerant in the Rankine-cycle condenser may be set in the same area as those of an inlet and an outlet of the refrigerant in the refrigeration-cycle condenser as viewed from the flow direction of the external air.

Thus, an inflow area and an outflow area of the refrigerant in the Rankine-cycle condenser can have the same positional relationship as that of an inflow area and an outflow area of the refrigerant in the refrigeration-cycle condenser. The amount of increase in temperature of the external air having passed through the Rankine-cycle condenser is high on the inflow side of the refrigerant of the Rankine-cycle condenser, and becomes lower toward its outflow side. It is apparent that the temperature of the refrigerant in the refrigeration-cycle condenser becomes lower from its inflow side toward its outflow side by heat exchange. This can provide such a positional relationship that temperature distribution of the external air flowing into the refrigeration-cycle condenser has the same tendency as that of the refrigerant flowing into the refrigeration-cycle condenser. Thus, a difference in temperature between the external air and the refrigerant for the refrigeration can be entirely made uniform in the refrigeration-cycle condenser, and thereby it can effectively radiate heat from the refrigeration-cycle condenser.

Accordingly, the refrigeration apparatus may further include an air-introduction flow path portion for allowing the external air to be introduced into the refrigeration-cycle condenser from an upstream side of the external air of the Rankine-cycle condenser through a space between the Rankine-cycle condenser and the refrigeration-cycle condenser, and an opening adjustment portion for adjusting an area of an opening toward the Rankine-cycle condenser and an area of an opening toward the air-introduction flow path portion by being moved under control of the control means. Accordingly, the amount of external air flowing into each condenser can be adjusted according to the necessary amount of heat radiated from each of the condensers for the refrigeration cycle and the Rankine cycle, so as to enable effective heat radiation at the respective condensers.

Furthermore, an area of a front surface of the Rankine-cycle condenser is made to be smaller than that of a front surface of the refrigeration-cycle condenser, and the refrigeration-cycle condenser has an area at an upstream side of the external air, where the Rankine-cycle condenser is not superimposed. Thus, the external air whose temperature is equal to the outside air temperature and which is not subjected to the heat exchange at the Rankine-cycle condenser can flow directly into the refrigeration-cycle condenser, so that the radiation capacity of the radiator for the refrigeration cycle can be improved.

Further, a dimension of the Rankine-cycle condenser in a flow direction of the external air may be set larger than that of the refrigeration-cycle condenser. Accordingly, it is possible to obtain a higher heat radiation capacity in the Rankine-cycle condenser by increasing a dimension of the external air in the direction of flow, and easily decrease an area of the front surface of the Rankine-cycle condenser.

An inlet and an outlet of the refrigerant in the Rankine-cycle condenser may be provided to be opened toward an upstream side in a flow direction of the external air. Thus, it is not necessary to dispose piping between the Rankine-cycle condenser and the refrigeration-cycle condenser in routing piping for refrigerant in the refrigeration-cycle condenser. Furthermore, it enables easy connection of the piping to the Rankine-cycle condenser.

Furthermore, the inlet and the outlet of the refrigerant in the refrigeration-cycle condenser may be provided to be opened in a direction perpendicular to a flow direction of the external air.

### BRIEF DESCRIPTION OF THE DRAWINGS

Additional objects and advantages of the present invention will be more readily apparent from the following detailed description of preferred embodiments when taken together with the accompanying drawings. In which:

FIG. 1 is a schematic diagram showing an entire system of a refrigeration apparatus with an exhaust heat recovery device according to a first embodiment of the invention;

FIG. 2 is a side view showing a mounting state of a refrigeration-cycle condenser, a Rankine-cycle condenser, and a radiator on a vehicle in the first embodiment;

FIG. 3 is a perspective view showing an inlet and an outlet for refrigerant of each of the refrigeration-cycle condenser and the Rankine-cycle condenser in the first embodiment;

FIG. 4 is a perspective view showing connection directions of piping with the inlets and outlets for refrigerant and for coolant in each of the refrigeration-cycle condenser, the Rankine-cycle condenser, and the radiator in the first embodiment;

FIG. 5 is a control characteristic diagram showing an operation mode of an electric fan with respect to a refrigerant pressure in the first embodiment;

FIG. 6 is a flowchart showing a control method for simultaneously operating the refrigeration cycle and the Rankine cycle in the first embodiment;

FIG. 7 is a map for calculating an optimal rotation speed (number of revolutions) of an expansion unit according to the first embodiment;

FIG. 8 is a plan view showing a duct and a guide in a second embodiment of the invention;

FIG. 9 is a perspective view showing a refrigeration-cycle condenser and a Rankine-cycle condenser in a third embodiment of the invention; and

FIG. 10 is a perspective view for supplemental explanation, showing the refrigeration-cycle condenser and the Rankine-cycle condenser in the third embodiment.

### DETAILED DESCRIPTION OF THE PREFERRED EMBODIMENTS

### First Embodiment

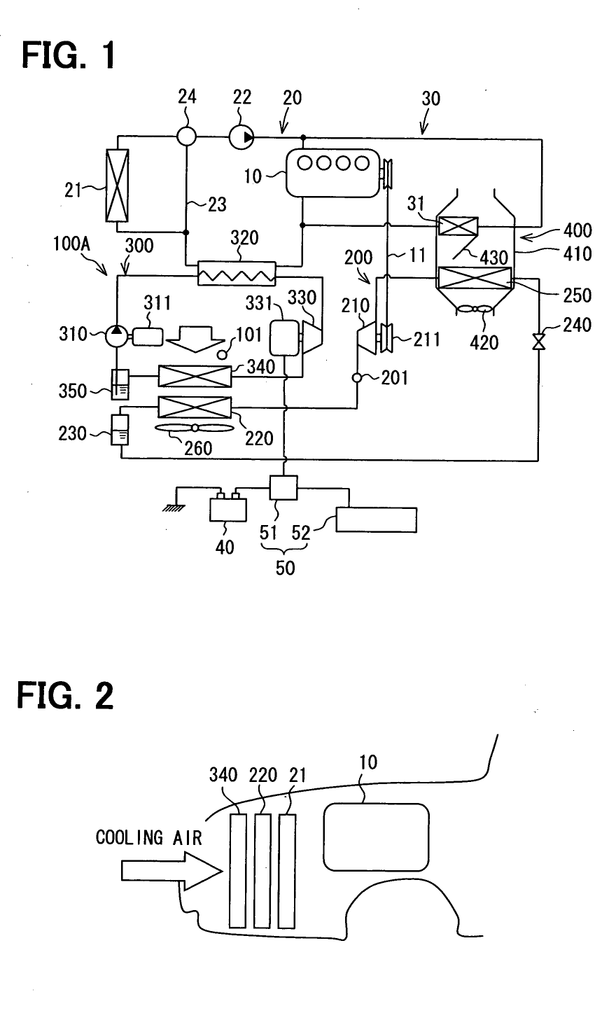

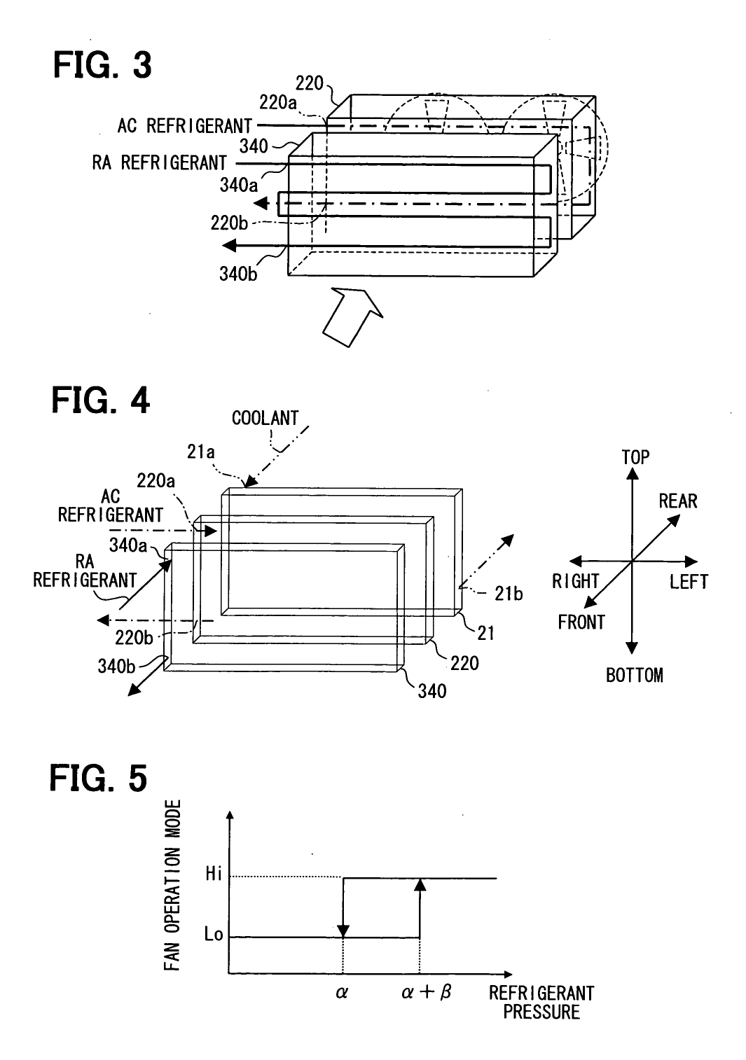

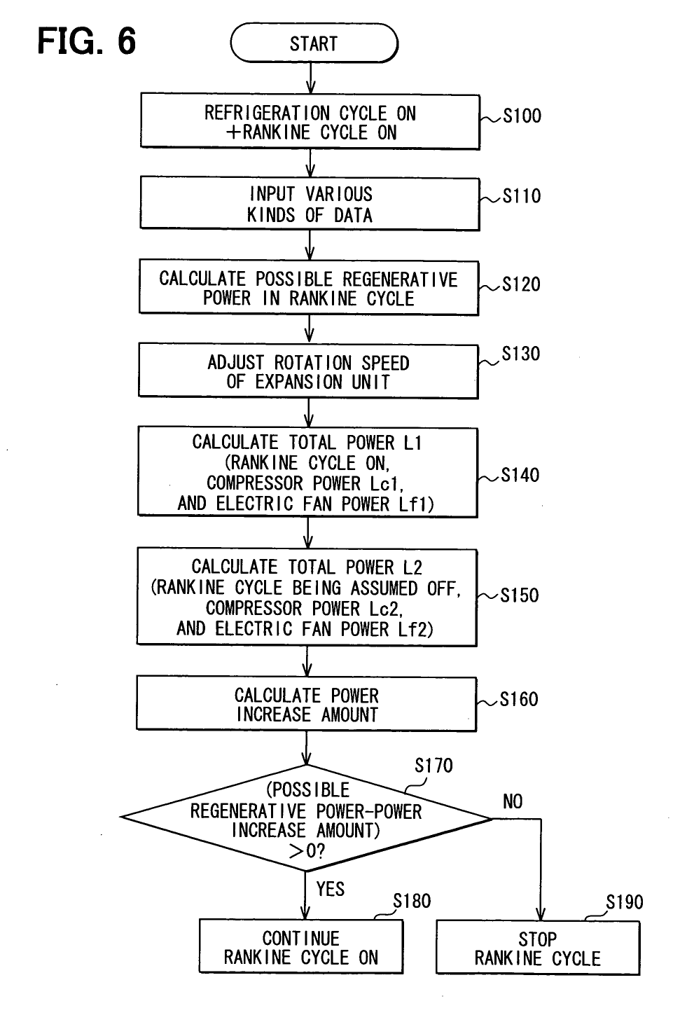

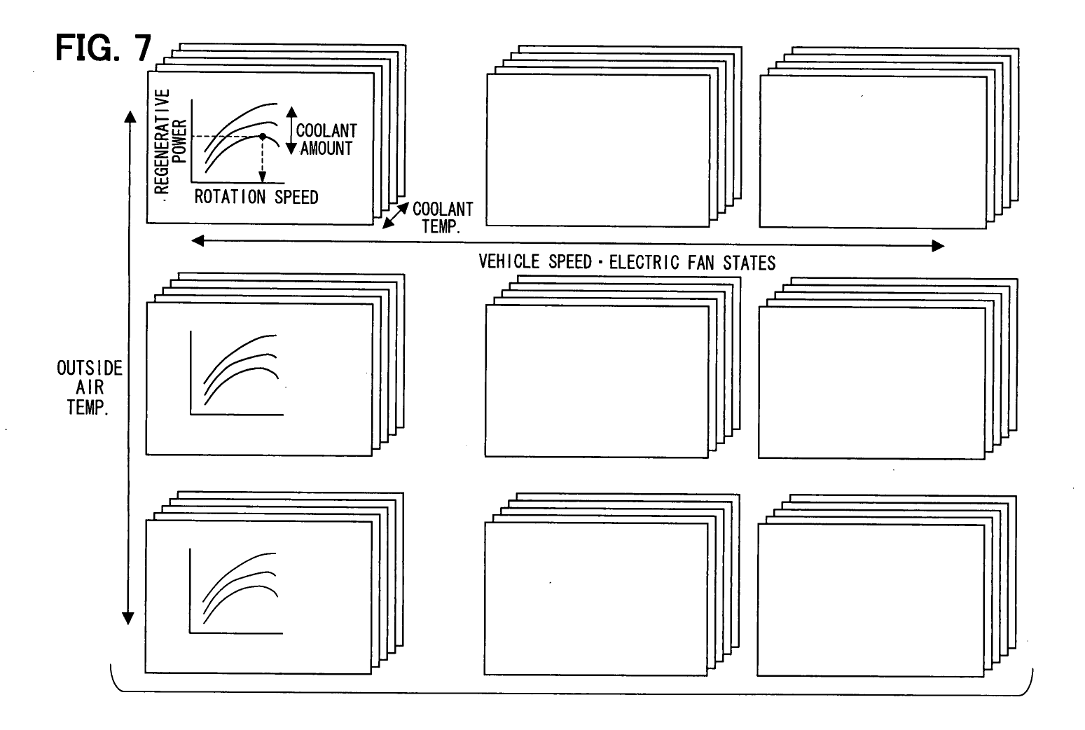

A first embodiment of the invention is shown in FIGS. 1 to 7. First, the specific structure of the first embodiment will be described below. FIG. 1 is a schematic diagram showing an entire system of a refrigeration apparatus 100A with an exhaust heat recovery device (hereinafter referred to as a “refrigeration apparatus”). FIG. 2 is a side view showing a mounting state of a Rankine-cycle condenser 340 (hereinafter referred to as an “RA condenser”), a refrigeration-cycle condenser 220 (hereinafter referred to as an “AC condenser”), and a radiator 21 on a vehicle. FIG. 3 is a perspective view showing inlets 340a and 220a and outlets 340b and 220b for refrigerant of the RA condenser 340 and the AC condenser 220. FIG. 4 is a perspective view showing connection directions of piping with the inlets 340a, 220a and 21a, and the outlets 340b, 220b and 21b for refrigerant and coolant of the RA condenser 340, the AC condenser 220, and the radiator 21. FIG. 5 is a control characteristic diagram showing operation modes of an electric fan 260 with respect to refrigerant pressures. FIG. 6 is a flowchart 1 showing a control method for simultaneously operating a refrigeration cycle 200 and a Rankine cycle 300. Furthermore, FIG. 7 is a map for calculating an optimal number of revolutions of an expansion unit 330.

As shown in FIG. 1, the refrigeration apparatus 100A of the first embodiment is applied to a vehicle using an engine 10 as a driving source. The refrigeration apparatus 100A is provided with the refrigeration cycle 200 and the Rankine cycle 300. The operations of the respective cycles 200 and 300 are controlled by an energization control circuit 50.

The engine 10 is a water-cooled internal combustion engine (corresponding to a heat engine in the invention), and is provided with a radiator circuit 20 for cooling the engine 10 by circulation of engine coolant, and a heater circuit 30 for heating conditioned air (i.e., air to be conditioned) using the coolant (warm water) as a heating source.

The radiator circuit 20 is provided with the radiator 21, which cools the coolant circulating by a warm water pump 22, by performing heat exchange with outside air. The warm pump 22 may be either an electric pump or a mechanical pump. A heater 320 in the Rankine cycle 300 to be described later is disposed in a flow path on the outlet side of the engine (in a flow path between the engine 10 and the radiator 21), so that the coolant flows through the heater 320. A radiator bypass flow path 23 for bypassing the radiator 21 and for allowing the coolant to flow therethrough is provided in the radiator circuit 20. A thermostat 24 adjusts an amount of coolant flowing through the radiator 21 and an amount of coolant flowing through the radiator bypass flow path 23.

The heater circuit 30 is provided with a heater core 31, and allows the coolant (warm water) to circulate therethrough by the above-described warm water pump 22. The heater core 31 is disposed in an air conditioning case 410 of an air conditioning unit 400, and heats the conditioned air blown by the blower 420 by heat exchange with the warm water. The heater core 31 is provided with an air mix door 430. The air mix door 430 is opened or closed to adjust the amount of conditioned air flowing through the heater core 31.

The refrigeration cycle 200 includes a compressor 210, an AC condenser 220, a liquid receiver 230, an expansion valve 240, and an evaporator 250, which are connected in an annular shape to form a closed circuit. The compressor 210 is a fluid device for compressing refrigerant in the refrigeration cycle 200 at a high temperature and a high pressure (here, the refrigerant corresponds to refrigerant for refrigeration in the invention, and which is hereinafter referred to as an “AC refrigerant”). The compressor 210 is driven by a driving force of the engine 10. That is, a pulley 211 serving as driving means is fixed to a driving shaft of the compressor 210, so that the driving force of the engine 10 is transferred to the pulley 211 via a belt 11 to drive the compressor 210. The pulley 211 is provided with an electromagnetic clutch not shown for intermittently connecting between the compressor 210 and the pulley 211. The intermittent connection of the electromagnetic clutch is controlled by the energization control circuit 50 to be described later. The AC refrigerant circulates through the refrigeration cycle 200 by operating the compressor 210.

The AC condenser 220 is connected to the discharge side of the compressor 210. The condenser 220 is a heat exchanger for condensing and liquifying the AC refrigerant flowing therethrough by heat exchange with cooling air (corresponding to external air in the invention). The liquid receiver 230 is a receiver for separating the AC refrigerant condensed by the AC condenser 220 into two liquid-gas phases, and allows the only liquefied AC refrigerant separated to flow out toward the expansion valve 240. The expansion valve 240 decompresses and expands the liquefied AC refrigerant from the liquid receiver 230. This embodiment employs a thermal expansion valve for isentropically decompressing the AC refrigerant, and for controlling an opening degree of a throttle such that a degree of superheat of the AC refrigerant drawn from the evaporator 250 into the compressor 210 has a predetermined value.

The evaporator 250 is disposed in the air conditioning case 410 of the air conditioning unit 400, like the heater core 31. The evaporator 250 is a heat exchanger for evaporating the AC refrigerant decompressed and expanded by the expansion valve 240, and for cooling the conditioned air from the blower 420 by latent heat of the evaporation at that time. The refrigerant outlet side of the evaporator 250 is connected to the suction side of the compressor 210. A mixture ratio of air cooled by the evaporator 250 to air heated by the heater core 31 is changed according to the opening degree of the air mix door 430, so that the temperature of the conditioned air is adjusted to a certain temperature set by a passenger.

A pressure sensor 201 is located between the compressor 210 and the AC condenser 220 to detect a pressure (high-pressure side pressure PHa) of the AC refrigerant. The pressure signal (PHa) detected by the pressure sensor 201 is output to the energization control circuit 50.

In contrast, the Rankine cycle 300 is adapted to recover exhaust heat energy generated by the engine 10 (heat from the coolant), and to convert the exhaust heat energy into mechanical energy (e.g., a driving force of the expansion unit 330), and further into electric energy (i.e., electric power generated by an electric generator 331) in use. The Rankine cycle 300 will be described below.

The Rankine cycle 300 includes a pump 310, a heater 320, an expansion unit 330, a condenser 340, and a liquid receiver 350, which are connected in an annular shape to form a closed circuit.

The pump 310 is an electric pump for allowing the refrigerant in the Rankine cycle 300 to circulate therethrough (which corresponds to refrigerant for the Rankine cycle in the invention, and which is hereinafter referred to as an “RA refrigerant”) using an electric motor 311 as a driving source. The electric motor 311 is operated by the energization control circuit 50 to be described later. The RA refrigerant is the same refrigerant as the above-described AC refrigerant. The heater 320 is a heat exchanger for heating the RA refrigerant by heat exchange between the RA refrigerant fed from the pump 310 and the high-temperature coolant circulating through the radiator circuit 20.

The expansion unit 330 is a fluid device for generating a rotation driving force by expansion of the superheated-steam RA refrigerant heated by the heater 320. The electric generator 331 is connected to a driving shaft of the expansion unit 330. The electric generator 331 is operated by the driving force of the expansion unit 330 as will be described later, so that electric power generated by the electric generator 331 is charged into a battery 40 via an inverter 51 included in the energization control circuit 50 to be described later. The RA refrigerant flowing from the expansion unit 330 leads to the RA condenser 340.

The RA condenser 340 is connected to the discharge side of the expansion unit 330. The condenser 340 is a heat exchanger for condensing and liquifying the RA refrigerant flowing therethrough by heat exchange with cooling air (corresponding to external air in the invention). The liquid receiver 350 is a receiver for separating the RA refrigerant condensed by the RA condenser 340 into two liquid-gas phases, and allows only the separated liquid RA refrigerant to flow out toward the pump 310.

A temperature sensor 101 is located at an inflow side of the RA condenser 340, from which the cooling air flows to the RA condenser 340, so as to detect the temperature of the cooling air (i.e., inflow air temperature Ta). The temperature signal (Ta) detected by the temperature sensor 101 is output to the energization control circuit 50 described later.

As shown in FIG. 2, the RA condenser 340 in the Rankine cycle 300, the AC condenser 220 in the refrigeration cycle 200, and the radiator 21 in the radiator circuit 20 are arranged on the rear side of a vehicle grill, that is, on the front side of an engine room. In running of the vehicle, the cooling air (external air) flows from the vehicle grill into the engine room. The RA condenser 340, the AC condenser 220, and the radiator 21 are arranged in series in that order from the upstream side to the downstream side with respect to the flow direction of the cooling air and mounted on the vehicle. The upstream side of the flow direction of the cooling air will be referred to as a “front side”, and the downstream side of the flow direction of the cooling air will be referred as a “rear side”, with respect to a position in the front/rear direction of the vehicle.

As shown in FIG. 3, the inlet 340a and the outlet 340b for the RA refrigerant are provided on one end side in the horizontal direction of the RA condenser 340 (on the right side in mounting of the condenser on the vehicle). The inlet 340a is disposed on the upper side (on the upper right side in mounting), and the outlet 340b is disposed on the lower side (on the lower right side in mounting). The inlet 220a and the outlet 220b of the AC refrigerant with respect to the AC condenser 220 are positioned in the same respective areas as those of the inlet 340a and the outlet 340b of the RA condenser 340. That is, the positions of the inlet 340a of the RA condenser 340 and of the inlet 220a of the AC condenser 220 are positioned on the upper right side in mounting of the condensers on the vehicle. The positions of the outlet 340b of the RA condenser 340 and of the outlet 220b of the AC condenser 220 are positioned on the lower right side in mounting.

Further, as shown in FIG. 4, the inlet 340a and the outlet 340b of the RA condenser 340 are opened to the forward side (the grill side), and the refrigerant piping is connected from the front side to the rear side. The inlet 220a and the outlet 220b of the AC condenser 220 are opened in the direction perpendicular to the flow direction of the cooling air (to the right side in the width direction of the vehicle), and the refrigerant piping is connected from the right side to the left side in the width direction. The inlet 21a and the outlet 21b of the coolant of the radiator 21 are opened toward the rear side (toward the engine 10 side), and the coolant piping is connected from the rear side to the front side.

An electric fan 260 in which an axial blower fan is rotatably driven by an electric motor serving as a driving source is provided on the rear side of the radiator 21 among the RA condenser 340, the AC condenser 220, and the radiator 21 that are arranged in series in the engine room (see FIG. 1). The electric fan 260 is the so-called suction-type blowing means for forcedly supplying the cooling air to the RA condenser 340, the AC condenser 220, and the radiator 21 from the front side to the rear side by rotatably driving the blower fan. When the sufficient amount of inflow of the cooling air is not expected from the vehicle grill (e.g., in idling, in climbing a slope at low speeds, or the like), and also when radiation capacities of the RA condenser 340, the AC condenser 220, and the radiator 21 cannot be derived sufficiently, the electric fan 260 is operated to promote the supply of the cooling air.

Specifically, as shown in FIG. 5, the operation of the electric fan 260 is controlled by the energization control circuit 50 to be described later. When the high-pressure side pressure PHa in the refrigeration cycle 200 is determined to be equal to or less than a by using the pressure sensor 201 (or when a temperature of the coolant in the refrigeration cycle 200 is equal to or less than a predetermined temperature), the electric fan 260 is operated in a low mode (Lo mode). Further, when the high-pressure side pressure PHa in the refrigeration cycle 200 is equal to or more than α+β (or when a temperature of the coolant is equal to or more than a predetermined temperature+γ), the electric fan 260 is operated in a high mode (Hi mode).

The energization control circuit 50 is control means for controlling the operations of various devices in the above-described refrigeration cycle 200 and the Rankine cycle 300, and includes the inverter 51 and a controller 52.

The inverter 51 is to control the operation of the electric generator 331 connected to the expansion unit 330. When the electric generator 331 is operated by the driving force of the expansion valve 330, the inverter 51 charges the generated power into the battery 40.

The controller 52 controls the operation of the inverter 51. Also, the controller 52 controls the electromagnetic clutch, the electric fan 260, the electric motor 311 of the pump 310, and the like by obtaining detection signals from the pressure sensors 101 and 201 in operating the refrigeration cycle 200 and the Rankine cycle 300.

Now, the operations and effects of this arrangement will be described below.

1. Single operation of Refrigeration Cycle

When a request for air conditioning is made while no exhaust heat is obtained during warming or the like directly after the startup of the engine 10, the energization control circuit 50 stops the electric motor 311 of the pump 310 while stopping the expansion unit 320, engages the electromagnetic clutch, drives the compressor 210 by the driving force of the engine 10, and singly drives the refrigeration cycle 200. In this case, the refrigeration cycle 200 operates in the same way as a normal air conditioner for a vehicle.

2. Single operation of Rankine Cycle

When the sufficient exhaust heat is generated from the engine 10 without a requirement for air conditioning, the energization control circuit 50 disconnects the electromagnetic clutch (stops the compressor 210), operates the electric motor 311 (the pump 310), and singly operates the Rankine cycle 300 thereby to generate electricity.

In this case, the RA liquid refrigerant in the liquid receiver 350 has a pressure increased by the pump 310 to be fed to the heater 320. By the heater 320, the RA liquid refrigerant is heated by high-temperature engine coolant to become RA superheated steam refrigerant, which is fed to the expansion unit 330. The RA superheated steam refrigerant is isentropically expanded and decompressed by the expansion unit 330, and has part of thermal energy and pressure energy converted into a rotation driving force. The rotation driving force taken by the expansion unit 330 operates the electric generator 331, which then generates the electricity. The electric power generated by the electric generator 331 is charged into the buttery 40 via the inverter 51, and then used for operations of various auxiliary devices. The RA refrigerant decompressed by the expansion unit 330 is condensed by the RA condenser 340, separated into liquid and gas phases by the liquid receiver 350, and drawn again into the pump 310.

3. Simultaneous Operation of Refrigeration Cycle and Rankine Cycle

When exhaust heat is sufficiently generated in a case where an air conditioning made is required, the energization control circuit 50 simultaneously drives and operates both the refrigeration cycle 200 and the Rankine cycle 300, thereby performing both of the air conditioning and the electricity generation.

In this case, the electromagnetic clutch is connected or engaged to operate the electric motor 311 (pump 310). The AC refrigerant and the RA refrigerant respectively circulate through the refrigeration cycle 200 and the Rankine cycle 300. The operation of each of the cycles 200 and 300 is the same as that in singly operating thereof.

In the simultaneous operation of the above-described refrigeration cycle and the Rankine cycle, because the AC condenser 220 is disposed on the rear side of the RA condenser 340, the cooling air with the outside air temperature flows into the RA condenser 340, and the cooling air which exchanges heat at the RA condenser 340 with its temperature increased flows into the AC condenser 220. Thus, the AC condenser 220 decreases a heat radiation capacity as compared to a case in which the cooling air with the outside air temperature (the external air not subjected to the heat exchange) purely flows thereinto. In accordance with this, the high-pressure side pressure PHa in the refrigeration cycle 200 is increased. When the high-pressure side pressure PHa is increased, the power of the compressor 210 or of the electric fan 260 may be increased to reduce the reliability on the compressor 210 and the electric fan 260 (electric motor), resulting in a decrease in coefficient of performance of the refrigeration cycle 200. Thus, taking into consideration a balance between a power increase amount of the refrigeration cycle 200 and an amount of regenerative power in the Rankine cycle 300, that is, in order to permit the regenerative power to exceed power increase amount, the energization control circuit 50 performs control for preventing deterioration of the balance in the Rankine cycle 300 based on a flowchart shown in FIG. 6 and a map shown in FIG. 7.

That is, when the refrigeration cycle and the Rankine cycle are simultaneously operated in step S100 shown in FIG. 6, the energization control circuit 50 reads various kinds of data in step S110. Various kinds of data include a flow amount by weight Gw of coolant calculated according to the number of revolutions of the warm water pump 22, a coolant temperature Tw associated with engine control, and a flow amount by weight Ga of the cooling air calculated according to a vehicle speed and an operating state of the electric fan 260. The data also include an inflow air temperature Ta detected by the temperature sensor 101, and a high-pressure side pressure PHa detected by the pressure sensor 201.

Then, in step S120, a possible regenerative power Lrp in the Rankine cycle 300 is calculated using the map shown in FIG. 7. The map in FIG. 7 shows a preset relationship of a regenerative power Le of the expansion unit 330 with respect to the number of revolutions Ne (rotation speed) of the expansion unit 330 using the flow amount by weight Gw of the coolant, the coolant temperature Tw, the flow amount by weight Ga of the cooling air, and the inflow air temperature (outside air temperature) Ta, respectively, as parameters. The regenerative power Le has such a property that it increases with increasing number of revolutions Ne of the expansion unit to have the maximum value. Then, a map, corresponding to the coolant flow amount by weight Gw, the coolant temperature Tw, the cooling-air flow amount by weight Ga and the inflow air temperature Ta read in step S110, is selected, so that the maximum value of the regenerative power Le under this condition is calculated as a possible regenerative power Lep.

In step S130, the number of revolutions Ne (rotational speed) of the expansion unit 330, corresponding to the possible regenerative power Lep calculated in step S120, is calculated in step S130, and the actual rotational speed of the expansion unit 330 during operation is adjusted so as to become the calculated number of revolutions Ne.

Then, in step S140, a power Lc1 of the compressor 210 and a power Lf1 of the electric fan 260 which are required for operating the refrigeration cycle 200 in operation of the Rankine cycle 300 are calculated, and both powers Lc1 and Lf1 are added together to calculate a total power L1. In this case, the temperature of the cooling air flowing through the RA condenser 340 into the AC condenser 220 (passing air temperature Tas) is increased to a higher level than the inflow air temperature Ta, so that the AC condenser 220 exchanges heat using the cooling air having the passing air temperature Tas.

The calculation of the compressor power Lc1 and the electric fan power Lf1 as described above will be performed as follows. That is, a pressure difference ΔP1 of the compressor 210 is calculated from the high-pressure side pressure PHa read in step S110, the number of revolutions of the compressor 210 calculated according to the number of revolutions of the engine, and the flow amount of the AC refrigerant. Then, the compressor power Lc1 is calculated based on the thus-obtained pressure difference ΔP1. Further, the electric fan power Lf1 is calculated from the operating state (Hi or Lo) of the electric fan 260 determined according to the high-pressure side pressure PHa.

Then, in step S150, when the Rankine cycle 300 is assumed to be stopped (OFF), the power Lc2 of the compressor 210 and the power Lf2 of the electric fan 260 which are required for operating the refrigeration cycle 200 are calculated, and both powers Lc2 and Lf2 are added together thereby to calculate the total power L2. In this case, since the RA condenser 340 does not exchange heat, the temperature of cooling air flowing into the AC condenser 220 through the RA condenser 340 is the same as the inflow air temperature Ta, so that the AC condenser 220 exchanges heat using the cooling air with the inflow air temperature Ta. That is, the heat radiation capacity of the AC condenser 220 is increased so as to decrease the high-pressure side pressure PHa as compared to a case in which the Rankine cycle 300 is operated, whereby the high-pressure side pressure at this time is calculated as an estimated high-pressure side pressure PHa2.

The calculation of the compressor power Lc2 and the electric fan power Lf2 as mentioned above will be performed as follows. That is, a pressure difference ΔP2 of the compressor 210 is calculated from the high-pressure side pressure PHa2 estimated as described above, the number of revolutions of the compressor 210 calculated according to the number of revolutions of the engine, and the flow amount of the AC refrigerant. Then, the compressor power Lc2 is calculated based on the thus-obtained pressure difference ΔP2. Further, the electric fan power Lf2 is calculated from the operating state (Hi or Lo) of the electric fan 260 determined according to the estimated high-pressure side pressure PHa2.

Then, in step S160, a power increase amount ΔL is calculated by performing subtraction between the total power L1 and the total power L2 respectively calculated in steps S140 and 150.

In step S170, it is determined whether or not a value obtained by subtracting the power increase amount ΔL from the possible regenerative power Lep is plus or not. When the value obtained by the subtraction becomes plus, the possible regenerative power Lep covers the operation of the refrigeration cycle 200, and an excessive regenerative power is obtained in simultaneous operation of the refrigeration cycle and the Rankine cycle.

When the value obtained by the subtraction is determined to be plus (If YES) in step S170, the operation of the Rankine cycle 300 is continued in step S180, thereby obtaining an effective regenerative power. If NO in step S170, the operation of the Rankine cycle 300 is stopped in step S190.

As mentioned above, in this embodiment, the refrigeration cycle 200 and the Rankine cycle 300 are provided with the dedicated AC condenser 220 and RA condenser 340, respectively, and the RA condenser 340 is positioned on the front side of the AC condenser 220 (on the upstream side of the cooling air flow). In operation of the Rankine cycle 300, the cooling air whose temperature is equal to the outside air temperature can constantly flow into the RA condenser 340, regardless of the presence or absence of the operation of the refrigeration cycle 200. This does not increase the refrigerant pressure in the RA condenser 340, and thus does not lead to reduction in pressure difference between the inlet and outlet of the expansion unit 330 and reduction in regenerative power.

In the singly operation of the Rankine cycle 300, the respective cycles 200 and 300 form the independent refrigerant circuits, and thus the refrigerant and lubricating oil are not collected from the Rankine cycle 300 into the refrigeration cycle 200, so that it can sufficiently exhibit the inherent capacity of the Rankine cycle 300, and ensure the reliability on the expansion unit 330 and the pump 310.

In general, this can provide the refrigeration apparatus 100A which can exhibit the sufficient performance of the Rankine cycle 300, while ensuring the reliability thereon.

In the simultaneous operation of the refrigeration cycle and the Rankine cycle, the number of revolutions Ne of the expansion unit is adjusted such that the regenerative power Le has an optimal value (possible regenerative power Lep) under a condition where power increase amount of the refrigeration cycle 200 is smaller than the regenerative power Le of the Rankine cycle 300. This can simultaneously operate the refrigeration cycle and the Rankine cycle, thereby surely obtaining the optimal regenerative power Le.

In simultaneous operating of the refrigeration cycle and the Rankine cycle, the operation of the Rankine cycle 300 is stopped under a condition where a power increase amount ΔL of the refrigeration cycle 200 is larger than the regenerative power Le of the Rankine cycle 300. This can prevent the regenerative power Le from decreasing below power increase amount ΔL, thereby eliminating a wasteful operation of the Rankine cycle 300. Because the external air whose temperature is the same as that of outside air flows into the AC condenser 220, it can prevent an increase in AC refrigerant pressure, an increase in power of the compressor 220, reduction of reliability thereon, and a decrease in coefficient of performance of the refrigeration cycle 200.

A possible regenerative power Les is calculated as the optimal value of the regenerative power Le of the expansion unit 330, using a map shown in FIG. 7. This can easily calculate power increase amount ΔL of the refrigeration cycle 200 and the optimal value of the regenerative power Le of the Rankine cycle 300.

The positions of the inlet 340a and outlet 340b of the RA condenser 340 are set in the same respective areas as those of the inlet 220a and outlet 220b of the AC condenser 220 as viewed in the flow direction of the cooling air. Thus, the inflow area and outflow area for the RA refrigerant in the RA condenser 340 can have the same positional relationship as that of the inflow area and outflow area for the AC refrigerant in the AC condenser 220. The amount of increase in temperature of cooling air passing through the RA condenser 340 is high on the inflow side of the RA refrigerant, and becomes lower toward the outflow side. It is apparent that the temperature of the AC refrigerant in the AC condenser 220 becomes lower from the inflow side toward the outflow side by the heat exchange. This can provide such a positional relationship that the temperature distribution of the cooling air flowing into the AC condenser 220 has the same tendency as that of the AC refrigerant into the AC condenser 220. Thus, the difference in temperature between the cooling air and the AC refrigerant can be entirely made uniform, and thereby it can effectively radiate heat from the AC condenser 220.

The inlet 340a and outlet 340b of the RA condenser 340 are opened toward the front side. Thus, it is not necessary to dispose piping between the RA condenser 340 and the AC condenser 220 in routing piping for the RA refrigerant to the RA condenser 340. This does not degrade a dimensional accuracy between both condensers 220 and 340, and can facilitate connection of the piping to the RA condenser 340.

The inlet 220a and outlet 220b of the AC condenser 220 are opened in the direction perpendicular to the flow direction of the cooling air. Thus, it is not necessary to dispose piping between the RA condenser 340 and the AC condenser 220, or to dispose piping from the front side to the rear side in routing piping for the AC refrigerant to the AC condenser 220. This can prevent degradation of a dimensional accuracy between both condensers 220 and 340, or a decrease in area of the front surface of the RA condenser 340. Further, this can also facilitate connection of the piping to the AC condenser 220.

In a balance deterioration preventing control as explained based on FIG. 6, in steps S140 and S150, the pressure differences ΔP1 and ΔP2 are calculated from the high-pressure side pressure PHa obtained from the pressure sensor 201, the number of revolutions of the compressor 210, and the AC refrigerant flow amount, and further the compressor powers Lc1 and Lc2 are calculated based on the pressure differences ΔP1 and ΔP2. Alternatively, such physical quantities may be previously put together into a map, from which the compressor powers LC1 and LC2 may be determined.

In steps S120 and S130, a possible regenerative power Lep and the number of revolutions Ne of the expansion unit corresponding thereto are calculated using the map. Alternatively, these elements may be calculated from an equilibrium formula based on thermal balance between the heater 320 side and the RA condenser 340 side of the Rankine cycle 300.

Furthermore, in steps S140 and S150, the compressor powers Lc1 and Lc2, and the total powers L1 and L2 may be calculated from an equilibrium formula based on thermal balance between the AC condenser 220 side and the evaporator 250 side of the refrigeration cycle 200.

### Second Embodiment

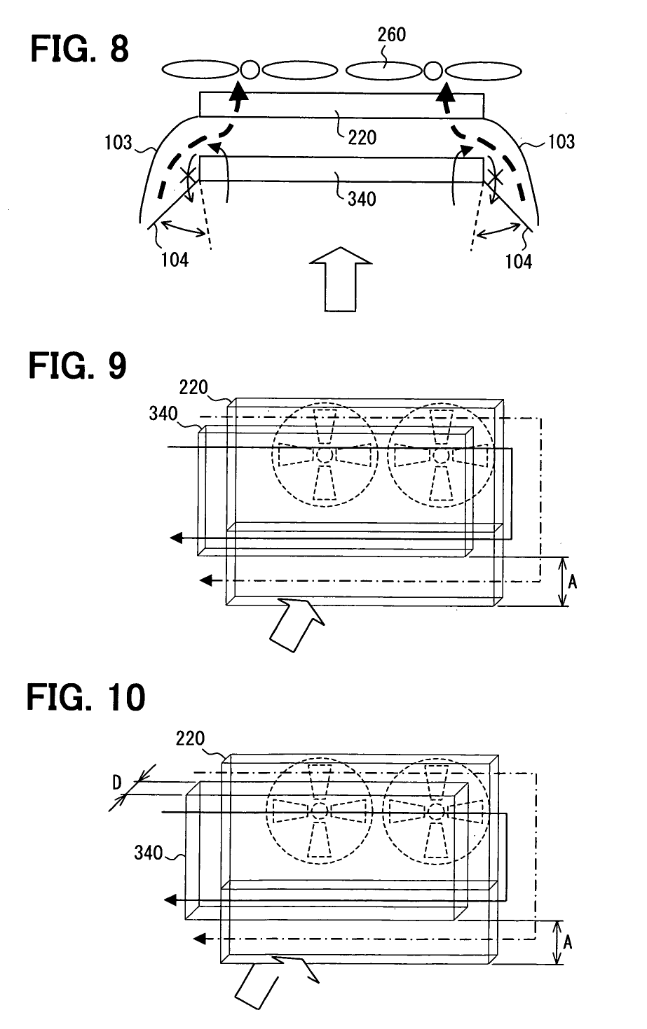

FIG. 8 shows a second embodiment of the invention. In the second embodiment, ducts 103 serving as an introduction flow path, and guides 104 serving as an opening adjustment portion are provided relative to the RA condenser 340 and the AC condenser 220 of the first embodiment.

The ducts 103 each of which is a plate-like member adapted for introduction of air are provided on both ends of the AC condenser 220 in the vehicle width direction. The ducts 103 are formed so as to expand from both ends of the AC condenser 220 to the front side of the RA condenser 340. As indicated by the dashed arrow in FIG. 8, the ducts 103 are formed so as to allow cooling air to be directly introduced into the AC condenser 220 through between the RA condenser 340 and the AC condenser 220 on both ends, without allowing the cooling air to pass from the front side of the RA condenser 340 through the RA condenser 340.

The guides 104 each of which is formed as a plate-like member are disposed on both ends of the RA condenser 340 in the vehicle width direction and adapted to be rotatably operated around the respective ends in the vehicle width direction by the energization control circuit 50. As indicated by the solid arrow in FIG. 8, when the guide 104 is rotated toward the outside in the vehicle width direction, an area of an opening to the RA condenser 340 is enlarged to increase an amount of inflow of the cooling air into the RA condenser 340. In contrast, as indicated by the dashed arrow in FIG. 8, when the guide 104 is rotated toward the inside in the vehicle width direction, an area of opening in a flow path formed by the duct 103, that is, a flow path directed toward between the RA condenser 340 and the AC condenser 220 is enlarged to increase an amount of inflow of the cooling air into the AC condenser 220.

In the second embodiment thus obtained, the position of rotation of the guide 104 is controlled by the energization control circuit 50 according to a necessary amount of heat radiated from each of the RA condenser 340 and the AC condenser 220. In other words, in singly operating of the refrigeration cycle 200, the guides 104 are controlled to be rotated according to the necessary amount of heat radiated from the AC condenser 220. The rotating of the guide 104 toward the inside in the vehicle width direction increases an amount of inflow of the cooling air into the AC condenser 220 without receiving a resistance on the RA condenser 340, thereby enabling improvement of heat radiation performance of the AC condenser 220.

In singly operating of the Rankine cycle, the guides 104 are controlled to be rotated according to the necessary amount of heat radiated from the RA condenser 340. The rotating of the guide 104 toward the outside in the vehicle width direction increases an amount of inflow of the cooling air into the RA condenser 340, thereby enabling improvement of heat radiation performance of the RA condenser 340. At this time, the guide 104 can prevent the cooling air having passed through the RA condenser 340 from flowing again into the RA condenser 340.

Furthermore, in simultaneously operating the refrigeration cycle and the Rankine cycle, the guides 104 are controlled to be rotated according to the necessary amount of heat radiated from both condensers 220 and 340. In this case, the guides 104 are rotated toward the outside in the vehicle width direction, thus allowing the cooling air whose temperature is the same as that of the outside air to flow into the AC condenser 220, thereby improving the heat radiation performance at the AC condenser 220.

In this way, the amounts of inflow of the cooling air into the condensers 220 and 340 are adjusted according to the respective necessary amounts of heat radiated from the AC condenser 220 and the RA condenser 340, thereby enabling effective heat radiation at each of the condensers 220 and 340.

### Third Embodiment

FIGS. 9 and 10 show a third embodiment of the invention. In the third embodiment, an area of a front surface of the RA condenser 340 is set to be smaller than that of a front surface of the AC condenser 220 so as to form an area (e.g., an A area shown in FIGS. 9 and 10) where both the condensers 220 and 340 are not overlapped with each other.

The dimension in the vertical direction of the RA condenser 340 is smaller than that of the AC condenser 220, so as to form the area where both the condensers 220 and 340 are not superimposed on each other on the lower side of the RA condenser 340.

If the dimension in the vertical direction of the RA condenser 340 is simply decreased, the heat radiation capacity of the RA condenser 340 may become small. Thus, as shown in FIG. 10, a thickness dimension D of a heat exchanging portion (i.e., a dimension in the flow direction of the cooling air) of the RA condenser 340 is set larger than that of a heat exchanging portion of the AC condenser 220 to ensure the heat radiation capacity of the RA condenser 340.

Thus, the cooling air which is not subjected to the heat exchange at the RA condenser 340 and whose temperature is equal to that of the outside air can directly flow into the AC condenser 220, thereby improving the heat radiation capacity of the AC condenser 220.

The thickness dimension D of the heat exchanging portion of the RA condenser 340 is increased by a decrease in area of the front surface of the RA condenser 340 to obtain the heat radiation capacity. This facilitates reduction in area of the front surface of the RA condenser 340.

### Other Embodiments

Although the present invention has been fully described in connection with the preferred embodiments thereof with reference to the accompanying drawings, it is to be noted that various changes and modifications will become apparent to those skilled in the art.

For example, set positions and opening directions of the inlets 220a and 340a and the outlets 220b and 340b of the AC condenser 220 and the RA condenser 340 are not limited to the contents described in each of the above-described embodiments, and may be any other position and direction.

The compressor 210 in the refrigeration cycle 200 is not limited to an engine-driving compressor driven by the engine 10, and also may be an electric compressor driven by an electric motor, or a hybrid compressor driven by an engine and an electric motor.

In the Rankine cycle 300, the pump 310 is driven by the electric motor 311, and the electric generator 331 is connected to the expansion unit 330. Alternatively, the electric motor 311 may be omitted, and the electric generator 331 may serve as a motor generator having both functions of an electric motor and an electric generator. The pump 310 and the expansion unit 330 may be connected to the motor generator.

In this case, in operating of the Rankine cycle 300, first, the motor generator acts as an electric motor to drive the pump 310. When exhaust heat is sufficiently obtained from the engine 10 and the driving force at the expansion unit 330 exceeds the power of the pump 310, the motor generator acts as an electric generator for generating electricity.

This can eliminate a driving source dedicated to drive the pump 310 (the electric motor 311 in each of the above-described embodiments), thereby simplifying the structure of the cycle, while decreasing energy for operating the pump 310.

Such changes and modifications are to be understood as being within the scope of the present invention as defined by the appended claims.

What is claimed is:

1. A refrigeration apparatus with an exhaust heat recovery device mounted on a vehicle, comprising:
a refrigeration cycle for allowing a refrigerant for refrigeration to circulate therethrough, the refrigeration cycle including a compressor, a refrigeration-cycle condenser, an expansion valve, and an evaporator which are connected in a circular shape; and
a Rankine cycle for allowing a refrigerant for the Rankine cycle to circulate therethrough, the Rankine cycle including a pump, a heater using exhaust heat from a heat engine of the vehicle as a heating source, an expansion unit, and a Rankine-cycle condenser which are connected in a circular shape,
wherein the refrigeration-cycle condenser and the Rankine-cycle condenser are disposed in predetermined positions of the vehicle in series with respect to a flow direction of external air for cooling, and
wherein the Rankine-cycle condenser is disposed on an upstream side of the external air with respect to the refrigeration-cycle condenser.

2. The refrigeration apparatus with an exhaust heat recovery device according to claim 1, further comprising control means for controlling operations of the refrigeration cycle and the Rankine cycle,
wherein the control means stops the operation of the Rankine cycle under a condition where a power increase amount due to the operation of the Rankine cycle, for operating the refrigeration cycle, is larger than a regenerative power in the Rankine cycle, when both of the refrigeration cycle and the Rankine cycle are simultaneously operated.

3. The refrigeration apparatus with an exhaust heat recovery device according to claim 1, further comprising control means for controlling operations of the refrigeration cycle and the Rankine cycle,
wherein the control means controls the number of revolutions of the expansion unit such that a regenerative power of the Rankine cycle has an optimal value under a condition where a power increase amount due to the operation of the Rankine cycle, for operating the refrigeration cycle, is smaller than the regenerative power of the Rankine cycle, when both of the refrigeration cycle and the Rankine cycle are simultaneously operated.

4. The refrigeration apparatus with an exhaust heat recovery device according to claim 3, wherein the control means calculates the power increase amount and the optimal value based on a map previously defined.

5. The refrigeration apparatus with an exhaust heat recovery device according to claim 3, wherein the control means calculates the power increase amount and the optimal value from a thermal equilibrium formula of a high-pressure side and a low-pressure side in each of the refrigeration cycle and the Rankine cycle.

6. The refrigeration apparatus with an exhaust heat recovery device according to claim 1, wherein positions of an inlet and an outlet of the refrigerant in the Rankine-cycle condenser are set in the same area as those of an inlet and an outlet of the refrigerant in the refrigeration-cycle condenser as viewed from the flow direction of the external air.

7. The refrigeration apparatus with an exhaust heat recovery device according to claim 1, further comprising an air-introduction flow path portion for allowing the external air to be introduced into the refrigeration-cycle condenser from an upstream side of the external air of the Rankine-cycle condenser through a space between the Rankine-cycle condenser and the refrigeration-cycle condenser, and
an opening adjustment portion for adjusting an area of an opening toward the Rankine-cycle condenser and an area of an opening toward the air-introduction flow path portion by being moved under control of the control means.

8. The refrigeration apparatus with an exhaust heat recovery device according to claim 1, wherein an area of a front surface of the Rankine-cycle condenser is made to be smaller than that of a front surface of the refrigeration-cycle condenser, and the refrigeration-cycle condenser has an area at an upstream side of the external air, where the Rankine-cycle condenser is not superimposed.

9. The refrigeration apparatus with an exhaust heat recovery device according to claim 8, wherein a dimension of the Rankine-cycle condenser in a flow direction of the external air is set larger than that of the refrigeration-cycle condenser.

10. The refrigeration apparatus with an exhaust heat recovery device according to claim 1, wherein an inlet and an outlet of the refrigerant in the Rankine-cycle condenser is provided to be opened toward an upstream side in a flow direction of the external air.

11. The refrigeration apparatus with an exhaust heat recovery device according to claim 1, wherein an inlet and an outlet of the refrigerant in the refrigeration-cycle condenser is provided to be opened in a direction perpendicular to a flow direction of the external air.

12. The refrigeration apparatus with an exhaust heat recovery device according to claim 1, wherein the Rankine-cycle condenser and the refrigeration-cycle condenser are disposed on an upstream side of the external air with respect to a radiator located in a radiator circuit of the vehicle, and
wherein the Rankine-cycle condenser, the refrigeration-cycle condenser, and the radiator are disposed at predetermined positions of the vehicle in series with respect to a flow direction of the external air for cooling.

13. The refrigeration apparatus with an exhaust heat recovery device according to claim 12, wherein the Rankine-cycle condenser, the refrigeration-cycle condenser, and the radiator are disposed on a front side in an engine room, at a rear side of a vehicle grill.
